(19) United States
(12) Patent Application Publication
(10) Pub. No.: US 2007/0113260 A1
(43) Pub. Date: May 17, 2007

(54) [STORAGE MEDIA WITH RECEIVING DIGITAL TELEVISION SIGNAL FUNCTION]

(75) Inventors: Khein-Seng Pua, TAIPEI (TW); Chih-Ling Wang, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: PHISON ELECTRONICS CORP., Hsinchu Hsien (TW)

(21) Appl. No.: 11/164,248

(22) Filed: Nov. 16, 2005

(51) Int. Cl. H04N 7/173; H04N 7/16

(52) U.S. Cl. 725/134; 725/142; 725/90

(57) ABSTRACT

A storage media with receiving digital TV and radio signal function is provided. The storage media comprises a digital TV signal module, a control device and a flash memory. The digital TV signal module comprises a receiver for receiving digital TV signal and a digital TV signal transmission interface. The control device comprises a digital TV signal transmission interface orderly connected to a microprocessor and a data transmission interface provided for connecting to an electronic device. The flash memory is electrically connected to the microprocessor of the control device.

### BACKGROUND OF THE INVENTION

1. Field of the Invention

The present invention relates to a storage media with receiving digital television (TV) and radio signal function, and more particularly to a storage media capable of receiving and transmitting digital TV signal to an electronic device for playing. The small size of the storage media provides a greater convenience for recording.

2. Description of Related Art

The rapid development of nonvolatile flash memory from mask-ROM, OTPROM, EPROM, EEPROM to flash memory was because of the advantages of the flash memory. Not only the reading speed of the flash memory is fast but also consumes no power to store data, and therefore the flash memory has become very popular in the semiconductor industry. Some manufacturers design latest storage devices including control IC with flash memory, such as the portable disk or the memory card. Because of the advantages of low power consumption, nonvolatile, shock proof and high density of the flash memory requiring no motor and magnetic head or other components, and therefore the size of the flash memory can be smaller to fit the requirement of the digital camera, MP3, PDA and other electronic products. Therefore, the flash memory as a storage device is very important. Besides, the cost of the flash memory is substantially lower compared to RAM, and to replace RAM with flash memory, the capacity of the flash memory may be used as the buffer. This would substantially reduce the cost of the product and can be accordingly attractive to the buyers.

Continuous advancement of audio/video technologies has developed a variety of TVs, computers, VCDs, DVDs, audio/video recorders, walkman, MP3s and the like. However, the audio/video device is individual host, and is required to be connected to external a stereo system via connection wires. Furthermore, the stereo system is required to be equipped with a monitor and speakers for displaying images and outputting the sound. Examples of presently available displays of audio/video systems are TV and computer, which are capable of displaying in specific modes. A cable is required for connecting to the signal receiver of the TV for receiving video/audio signals, and the computer monitor is required to be connected to a host for displaying data. Nowadays, the computer monitor has different purposes; the computer can be connected to the internet to receive signals of source located at far away distance. Furthermore, a computer camera may also be connected to implement on-line video communication connection. After the computer initiates connection to the camera for online video communication with the source located at a far away distance, the computer monitor functions like the TV monitor. However, the computer and the TV set have different designs, as well as receiving, transmission and playing programs are different. Therefore, the TV box or TV card is required for converting the signals accordingly to watch TV program on the computer.

Accordingly, how to use the advantages of the flash memory to minimize the size of the storage device and also to combine the audio/video signal receiving and transmission function to manufacture a portable storage device capable of providing the aforementioned audio/video features and benefits to users without the limit of time and location is very important target. Furthermore, the use of fund card, identity certificate or digital signature therein is also an important target for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a small size portable storage media with receiving digital TV and radio signal function.

According to an aspect of the present invention, the storage media comprises a receiver capable of receiving digital TV and radio signals so that the portable storage media can be easily connected to an electronic device rendering the electronic device to receive the digital TV and radio signals and display/output images/sound and as well as to store the audio/video signals into the store media.

According to another aspect of the present invention, a smartcard IC may be used to compare a specific key of a user with a key stored in the storage media for secured connections required using fund card, credit card, identity certificate or digital signal to enable the user to watch a specific pay channel for the specific time period.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of a storage media according to an embodiment of the present invention.

FIG. 2 is a flowchart of an operation procedure of a storage media according to an embodiment of the present invention.

FIG. 3 is a block diagram of a storage media according to another embodiment of the present invention.

FIG. 4 is a flowchart of an operation procedure of a storage media according to another embodiment of the present invention.

### DETAILED DESCRIPTION OF THE EMBODIMENTS

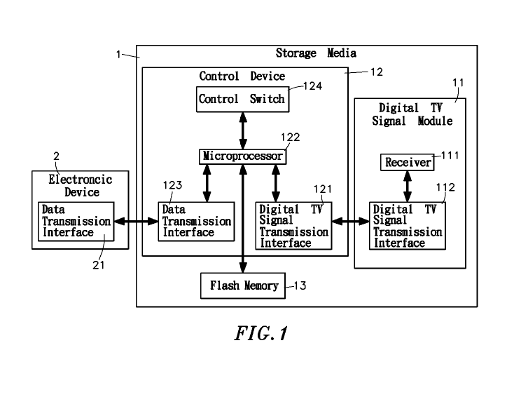

Referring to FIG. 1, a storage media 1 with receiving digital TV and radio signal function of the present invention comprises a digital TV signal module 11, a control device 12 and a flash memory 13.

The digital TV signal module 11 comprises a receiver 111 for receiving digital TV signal and a digital TV signal transmission interface 112.

The control device 12 comprises a digital TV signal transmission interface 121, which is identical to the digital TV signal transmission interface 112 of the digital TV signal module 11. The digital TV signal transmission interface 121 is connected to a microprocessor 122 and a data transmission interface 123 connected to an electronic device 2 in an orderly manner. The microprocessor 122 is also connected to a control switch 124.

The flash memory 13 may be electrically connected to the microprocessor 122 of the control device 12.

When the storage device 1 is connected to a data transmission interface 21 of the electronic device 2 via the data transmission interface 123, the electronic device 2 initiates the data retrieval/storage process from/to the storage media 1. The control device 12 of the storage media 1 receives data from the electronic device 2 via the data transmission interface 21 of the electronic device 2 and the data transmission interface 123 of the control device 1, and transmits the data to the flash memory 13 for storage therein. The control device 12 of the storage media 1 also transmits data stored in the flash memory 13 to the electronic device 2 via the data transmission interface 123 of the storage media 1 and the data transmission interface 21 of the electronic device 2. Thus, the storage media 1 is portable and is capable of processing data retrieval/storage in any location to add facility.

The abovementioned storage media 1 may comprise one or more flash memories 13. The storage media 1 may be a portable disk, a memory card or a hard disk. The data transmission interfaces 123 and 21 may be a USB transmission interface, a SATA transmission interface or a PCI transmission interface. Furthermore, the electronic device 2 may be a desktop computer, a notebook computer or a PDA.

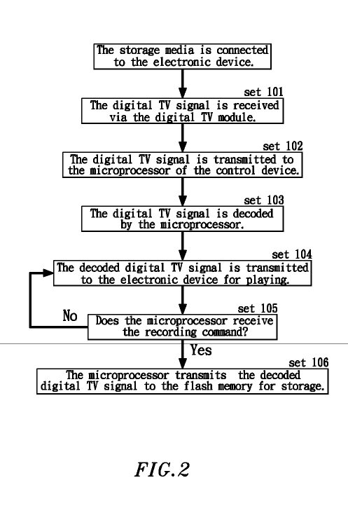

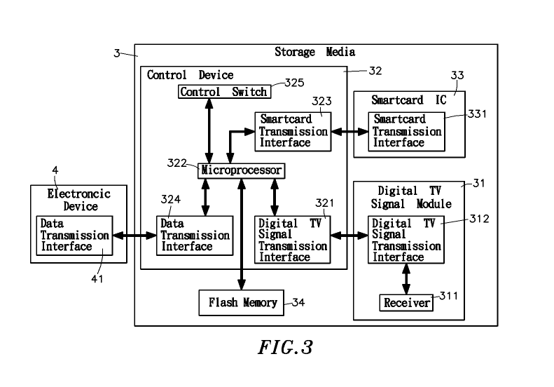

Referring to FIG. 2 and 3, when the data transmission interface 123 of the storage media 1 is connected to the data transmission interface 21 of the electronic device 2, a user can use the storage media 1 to receive a digital TV signals. First, the receiver 111 of the digital TV signal module 11 of the storage media 1 is adopted for receiving a digital TV signal. Then, the digital TV signal transmission interface 112 of the digital TV signal module 11 and the digital TV signal transmission interface 121 of the control device 12 transmit the digital TV signal to the microprocessor 122 of the control device 12 to decode. After the microprocessor 122 completes the decoding process, the decoded digital TV signal is transmitted to the electronic device 2 via the data transmission interface 123 and 21 for playing through a monitor and a speaker of the electronic device 2.

For the recording procedure, the electronic device 2 issues a recording command to the microprocessor 122 of the control device 12 via the data transmission interface 21 of the electronic device 2 and the data transmission interface 123 of the storage media 1. Next, the microprocessor 122 transmits the decoded digital TV signal to the electronic device 2 via the data transmission interfaces 123 and 21, and also the decoding digital TV signal is stored into the flash memory 13. Furthermore, the user may also activate the control switch 124 of the control device 12 for recording while playing the decoded digital TV signal. The control switch 124 will issue a recording command to the microprocessor 122, and the microprocessor 122 transmits the decoded digital TV signal to the electronic device 2 via the data transmission interface 123 and 21, and also the decoded digital TV signal is stored into the flash memory 13. Thus, the storage device 1 is portable and is capable of playing the digital TV signal by using the electric device 2 in any location.

The receiver 111 may serve as a connecting port for a TV cable as well as serve as an antenna for receiving the digital TV signal. The digital TV signal may be a digital video broadcasting-terrestrial (DVB-T), an advanced TV systems committee (ATSC) or an integrated service digital broadcasting-terrestrial (ISDB-T).

The operation procedure of the storage device 1 is described with reference to FIG. 1 and 2 as follows.

At step 100, the storage media 1 is connected to the electronic device 2.

At step 101, the digital TV signal is received via the digital TV signal module 11.

At step 102, the digital TV signal is transmitted to the microprocessor 122 of the control device 12.

At step 103, the digital TV signal is decoded by the microprocessor 122.

At step 104, the decoded digital TV signal is transmitted to the electronic device 2 for playing.

At step 105, the microprocessor 122 judges whether the recording command is received, if yes, the procedure proceeds to step 106, otherwise, the procedure proceeds to step 104.

At step 106, the microprocessor 122 transmits the decoded digital TV signal to the flash memory 13 for storage.

Referring to FIG. 3, a storage media 3 comprises a digital TV signal module 31, a control device 32, a smartcard IC 33 and a flash memory 34.

The digital TV signal module 31 comprises a receiver 311 for receiving digital TV signal and a digital TV signal transmission interface 312.

The control device 32 comprises a digital TV signal transmission interface 321 identical to the digital TV signal transmission interface 312 of the digital TV signal module 31. The digital TV signal transmission interface 321 is connected to the microprocessor 322. The microprocessor 322 is connected to a smartcard transmission interface 323 and a data transmission interface 324 connected to an electronic device 4. The microprocessor 322 is also connected to the control switch 325.

The smartcard IC 33 is connected to the smartcard transmission interface 323 of the control device 32 via a smartcard transmission interface 331. The smartcard IC 33 may comprise a fund card, an identity certificate and a digital signature function.

The flash memory 34 is electrically connected to the microprocessor 322 of the control device 32.

When the storage media 3 is connected to the data transmission interface 41 of the electronic device 4 via the data transmission interface 324, the electronic device 4 initiates the data retrieval/storage from/to the storage media 3. The control device 32 of the storage media 3 is adopted for retrieving data from the electronic device 4 via the connection of the data transmission interface 324 of the storage media 3 and the data transmission interface 41 of the electronic device 4, and storing the data into the flash memory 3. The control device 32 of the storage media 3 is also adopted for transmitting data stored in the flash memory 34 to the electronic device 4 via the connection of the data transmission interface 41 of the electronic 4 and the data transmission interface 324 of the storage media 3. Thus, the storage media 3 is portable and is capable of processing data retrieval/storage in any location to add facility.

The abovementioned storage media 3 may comprise one or more flash memories 34. The storage media 3 may be a portable disk, a memory card or a hard disk. The data transmission interfaces 324 and 41 may be a USB transmission interface, a SATA transmission interface or a PCI transmission interface. Furthermore, the electronic device 4 may be a desktop computer, a notebook computer or a PDA.

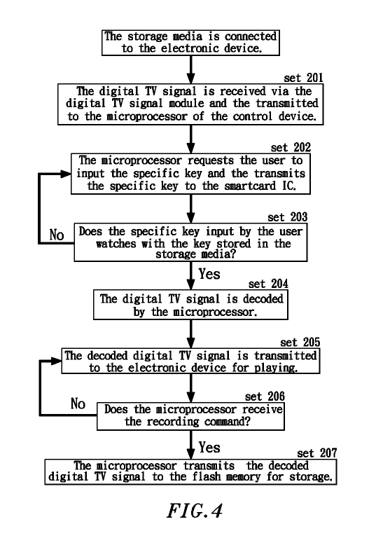

Referring to FIG. 3 and 4, a user can use the storage media 3 to receive a digital TV signal when the data transmission interface 324 of the storage media 3 is connected to a data transmission interface 41 of the electronic device 4. First, the receiver 311 of the digital TV signal module 31 of the storage media 3 is adopted for receiving a digital TV signal. Then, the digital TV signal transmission interface 312 of the digital TV signal module 31 and the digital TV signal transmission interface 321 of the control device 32 transmit the digital TV signal to the microprocessor 322 of the control device 32. The microprocessor 322 issues a requesting confirmation signal, and the confirmation signal may be transmitted to the electronic device 4 via the data transmission interface 324 and 41 to ask the user to input a specific key. When the user inputs the specific key via the electronic device 4, the microprocessor 322 transmits the specific key the smartcard IC 33 to compare with a key stored in the smartcard IC 33. If the two keys match, in response thereto, a signal may be transmitted to the microprocessor 322 for decoding the digital TV signal. After the microprocessor 322 completes decoding the digital TV signal, the decoded digital TV signal is transmitted to the electronic device 4 via the data transmission interfaces 324 and 41 for playing through a monitor and a speaker of the electronic device 4.

Furthermore, the smartcard IC 33 may be adopted to match the specific key inputted by the user with the key stored therein. Thus, the storage media 3 may provide the user with secured function for using fund card, identity certificate and digital signature. Therefore, the user may securely shop on-line through the Internet by connecting the storage media 3 to the electronic device 4 and also enjoy services provided by the pay channels.

For the recording procedure, the electronic device 4 issues a recording command, or the user may activate the control switch 325 of the control device 32 to start recording when the electronic device 4 is playing the decoded digital TV signal. The recording process can be operated by the method described above.

The receiver 311 serves as a connecting port for a TV cable as well as an antenna for receiving the digital TV signal. The digital TV signal may be a digital video broadcasting-terrestrial (DVB-T), an advanced TV systems committee (ATSC) or an integrated services digital broadcasting-terrestrial (ISDB-T).

The operation procedure of the storage device 3 is described with reference to FIG. 3 and 4 as follows.

At step 200, the storage media 3 is connected to the electronic device 4.

At step 201, the digital TV signal is received via the digital TV signal module 31 and then transmitted to the microprocessor 322 of the control device 32.

At step 202, the microprocessor 322 requests the user to input the specific key and then transmits the specific key to the smartcard IC 33.

At step 203, the smartcard IC 33 compares the specific key inputted by the user with the key stored therein, wherein if the tow keys match with each other, the procedure proceeds to step 204, otherwise the procedure returns to step 202.

At step 204, the digital TV signal is decoded by the microprocessor 322.

At step 205, the decoded digital TV signal is transmitted to the electronic device 4 for playing.

At step 206, the microprocessor 322 judges whether or not the recording command is received, wherein if the recoding command is received, the procedure proceeds to step 207, otherwise, the procedure returns to step 205.

At step 207, the microprocessor 322 transmits the decoded digital TV signal to the flash memory 13 for storage.

Accordingly, the storage media of the present invention at least has the following advantages.

1. The present invention provides the storage media with receiving digital TV and radio signal function. Thus, the storage media is not only capable of processing data retrieval/storage but also capable of receiving and transmitting the digital TV signal to the electronic device for playing on the go. Furthermore, the digital TV signal may be stored in the storage media as well.

2. The recording command may be issued by the electronic device, or the control switch of the control device may be activated to start recording while the electronic device is playing the decoded digital TV signal. Thus, the present invention provides the users a simple and convenient recording method.

3. The smartcard IC may be adopted for comparing the specific key inputted by the user with the key stored in the storage media to provide secured access to the storage media. Thus, it is possible to securely use fund card, identity certificate and digital signature. Therefore, the storage media may be connected to the electronic device to implement secured on-line shopping over the Internet.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A storage media with receiving digital TV and radio signal function, comprising:
a digital TV signal module, comprising a receiver for receiving digital TV signal and a digital TV signal transmission interface;
a control device, comprising a digital TV signal transmission interface orderly connected to a microprocessor and a data transmission interface provided for connecting to an electronic device; and
a flash memory, electrically connected to said microprocessor of said control device.

2. The storage media with receiving digital TV and radio signal function as claimed in claim 1, wherein said storage media comprises a portable disk.

3. The storage media with receiving digital TV and radio signal function as claimed in claim 1, wherein said storage media comprises a memory card.

4. The storage media with receiving digital TV and radio signal function as claimed in claim 1, wherein said data transmission interface comprises a USB transmission interface.

5. The storage media with receiving digital TV and radio signal function as claimed in claim 1, wherein said data transmission interface comprises a SATA transmission interface.

6. The storage media with receiving digital TV and radio signal function as claimed in claim 1, wherein said electronic device comprises a desktop computer.

7. The storage media with receiving digital TV and radio signal function as claimed in claim 1, wherein said electronic device comprises a notebook computer.

8. The storage media with receiving digital TV and radio signal function as claimed in claim 1, wherein said storage media comprises one or more flash memories.

9. The storage media with receiving digital TV and radio signal function as claimed in claim 1, wherein said receiver serves as a connecting port for a TV cable.

10. The storage media with receiving digital TV and radio signal function as claimed in claim 1, wherein said receiver serves as an antenna for receiving said digital TV signal.

11. The storage media with receiving digital TV and radio signal function as claimed in claim 1, wherein said control device comprises a smartcard transmission interface for connecting to a smartcard IC.

12. The storage media with receiving digital TV and radio signal function as claimed in claim 1, wherein said control device comprises a control switch.

13. The storage media with receiving digital TV and radio signal function as claimed in claim 1, wherein said digital TV signal comprises a digital video broadcasting-terrestrial (DVB-T).

14. The storage media with receiving digital TV and radio signal function as claimed in claim 1, wherein said digital TV signal comprises an advanced TV systems committee (ATSC).

15. The storage media with receiving digital TV and radio signal function as claimed in claim 1, wherein said digital TV signal comprises an integrated services digital broadcasting-terrestrial (ISDB-T).

16. The storage media with receiving digital TV and radio signal function as claimed in claim 1, wherein said flash memory comprises a NOR flash memory.

17. The storage media with receiving digital TV and radio signal function as claimed in claim 1, wherein said flash memory comprises a NAND flash memory.

18. The storage media with receiving digital TV and radio signal function as claimed in claim 1, wherein said flash memory comprises an AND flash memory.
